(19) United States
(12) Patent Application Publication
(10) Pub. No.: US 2007/0089663 A1
(43) Pub. Date: Apr. 26, 2007

(54) Semaphore apparatus

(76) Inventors: Dan Dunbar, Costa Mesa, CA (US); Steve Dunbar, Yorba Linda, CA (US)

Correspondence Address: Steve Dunbar, 5125 Avenida De Amor, Yorba Linda, CA, 92886, US

(21) Appl. No.: 11/258,699

(22) Filed: Oct. 26, 2005

(51) Int. Cl. G09F 17/00

(52) U.S. Cl. 116/173

(57) ABSTRACT

A signaling device for a water-skiing tow boat that displays a warning flag in the event of a fallen skier. The device can be attached to a boat hull or other structure and includes an electro-mechanical actuator operated by a local or remotely controlled switch or sensor to retract or extend the warning flag in or out of a weatherproof housing. To further enhance skier safety, an indicator light is used to attract attention in bright daylight as well as under low light conditions. The device can be operated by a radio-frequency link to remotely control the flag from any location around the tow boat and can be powered by the electrical system of the towing boat or by a rechargeable battery pack.

### FIELD OF THE INVENTION

The present invention relates to a signaling device for raising a warning flag and, more particularly, to a signaling device for boats used to pull water-skiers, to signal other boats and watercraft in the area that a water-skier has fallen in the water.

### BACKGROUND OF THE INVENTION

One of the problems that exist in water skiing, and particularly while water-skiing in congested lakes and other waterways, is that of making the driver of a towing boat, as well as the drivers of other boats in the area, aware that a water-skier has fallen.

In many cases, it may take several minutes before the towing boat driver realizes that a water-skier has fallen and is able to make a turn to retrieve the fallen skier. Operators of other boats in the area may also not be aware of the fallen skier for various reasons and may unintentionally strike or run over the fallen skier causing serious injuries and fatalities.

With the increased popularity of water sports, boating accidents have increased considerably and, in an effort to avoid such accidents, it has become the common practice to display a red flag on the towing boat whenever a skier has fallen and is in the water waiting to be picked up.

In addition, most states require that both the operator of the towing boat and an observer be present in the boat, to maintain constant surveillance of the skier's activities and to raise a warning flag when the skier has fallen. The warning flag is required to be conspicuously held up as long as the skier is in the water and not skiing.

Signaling flags are usually hand held by the boat operator, or by an observer riding in the towing boat, and the flag is typically placed within easy reach of the operator or observer, so that it can be quickly raised when it is needed.

However, objects that are unattached have a tendency to move and, while the boat is being maneuvered, may move to a position that is outside the reach of either the observer or the operator. As a consequence, some delay may occur between the time a skier falls and the observer or boat operator can retrieve the signaling flag and raise it. During that delay, an accident can easily occur. In addition, an observer may inadvertently drop the flag before the skier is safe.

If the operator of a towing boat uses one hand to hold a signaling flag, only one hand can be used for controlling the operation of the watercraft. Because of this, accidents are likely to occur, particularly when the boat is nearing the fallen skier and it is necessary to control both the direction of the boat and its speed.

As mentioned above, the signaling flag may have moved from its intended position in the towing boat so that the flag may not be easily accessible and may often be out of sight when under a seat or cushion. It is also possible that the signaling flag has been forgotten and is not in the boat when it is needed.

### BRIEF SUMMARY OF THE INVENTION

In accordance with the present invention, there is provided a signaling device for a water-skiing tow boat that displays a warning flag, in the event of a fallen skier, and retracts the warning flag into a weatherproof housing when the skier is safe.

The device can be attached to a boat hull or other structure and comprises a flag, a housing, a housing cover and an electromechanical actuator, operated by a local or remote switch or sensor, to quickly raise or lower the flag out of or into the housing. The device can also be operated remotely from any location around the tow boat using a radio frequency link.

To further enhance skier safety, an embodiment of the invention includes an indicator light to attract attention in bright daylight as well as under low light conditions.

Electrical power for the invention is provided by the tow boat power system or by a rechargeable battery supply.

It is therefore an object of the invention to provide a signaling device, attached to a water-skiing tow boat, that can quickly raise a warning flag in the event of a fallen skier and retract the warning flag into a weatherproof housing when the skier is safe.

It is another object of the invention to provide a signaling device, attached to a water-skiing tow boat, that is automatically actuated by an external sensor to raise a warning a flag in the event of a fallen skier and retract the warning flag into a weatherproof housing when the skier is safe.

It is another object of the invention to provide a signaling device, attached to a water-skiing tow boat, that is automatically actuated by a boat towline to raise a warning flag in the event of a fallen skier and retract the warning flag into a weatherproof housing when the skier is safe.

It is another object of the invention to provide a signaling device, attached to a water-skiing tow boat, that can be operated by a radio-frequency link to display a warning flag in the event of a fallen skier and retract the warning flag into a weatherproof housing when the skier is safe.

It is another object of the invention to provide a signaling device, attached to a water-skiing tow boat, that displays a warning flag and an indicator light in the event of a fallen skier and retracts the warning flag into a weatherproof housing and turns off the indicator light when the skier is safe.

It is another object of the invention to provide a battery-operated signaling device for a water-skiing tow boat that displays a warning flag in the event of a fallen skier and retracts the warning flag into a weatherproof housing when the skier is safe.

### BRIEF DESCRIPTION OF THE SEVERAL VIEWS OF THE DRAWINGS

FIG. 1 is an exploded view of a device of the invention;

FIG. 2 is a perspective view of the device of FIG. 1 with a signaling flag in a stowed position; and

FIG. 3 is a perspective view of the device of FIG. 1 with a signaling flag in a deployed position.

### DETAILED DESCRIPTION OF THE INVENTION

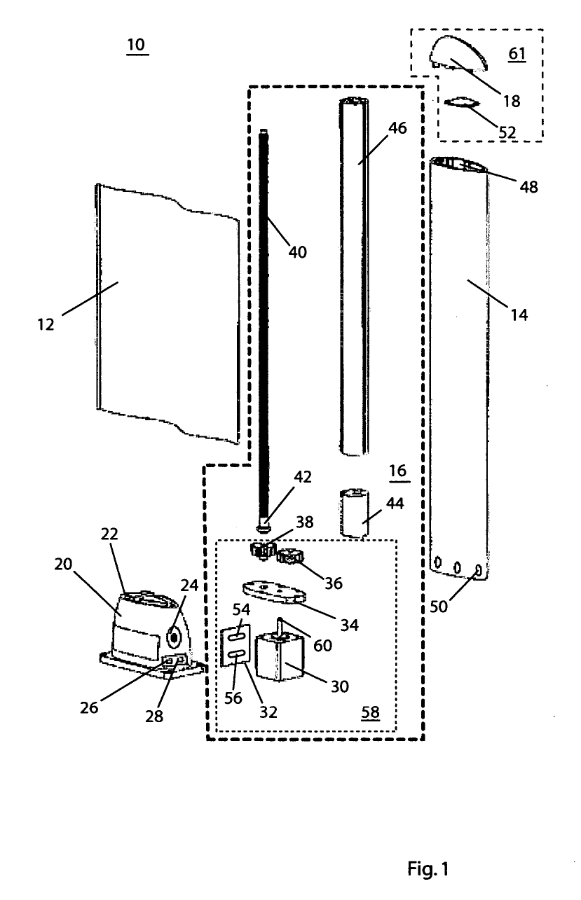

With reference to FIG. 1, a signaling device 10 for a water-skiing tow boat, that can be activated to extend and display a warning flag when a water-skier has fallen in the water and to retract the warning flag into a weatherproof housing when the skier is safe, comprises an electro-mechanical actuator assembly X, a flag 12, a mast housing 14, a housing cover assembly 61 and a mounting base enclosure 20.

The mounting base enclosure is adapted to provide support for the electromechanical actuator assembly, flag, mast housing and housing cover assembly and can be secured to the water-skiing tow boat hull or other structure using screws, bolts, clamps or other suitable attachment means well known in the art.

In addition, the mounting base enclosure contains a local actuator switch 24 to activate the signaling device, a remote connector 26 to interface external switches or sensors to the signaling device and a power connector 28 to input electrical power for the signaling device and may further include a waterproof sealing gasket 22 to prevent water and debris from entering the enclosure. Electrical power for a device of the invention can be provided by the electrical system of the towing boat or by a rechargeable battery supply connected to the power connector 28. The mast housing 14 is adapted to contain the flag and electromechanical actuator assembly and is configured with one or more guide grooves 48 to prevent the flag from rotating and consequently binding or tearing as it is extended from or retracted into the mast housing. The mast housing is attached to the mounting base enclosure using screws, bolts, clamps or other suitable attachment means.

Drain holes 50 are provided at the bottom of the mast housing to prevent moisture from entering the mounting base enclosure.

The electromechanical actuator assembly 16 comprises a flagpole 46, having an upper end and a lower end, a threaded lead screw 40 rotationally engaged with a threaded nut 44, and a gear motor assembly 58.

The flag is attached to the upper end of the flagpole and can be removably attached, to facilitate flag replacement, using screw, bolt, clip, clamp, groove, adhesive or other attachment means well known in the art. The flag is preferably made of cloth or other flexible material and is configured as a warning flag in accordance with water safety regulations.

The threaded nut is preferably attached to the bottom end of the flagpole and is operably engaged with the threaded lead screw to move the flagpole up and down on the threaded lead screw as the threaded lead screw rotates, thereby raising and lowering the flagpole and flag in and out of the mast housing.

One or more guide grooves 48 are provided along the interior wall of the mast housing 14 to prevent rotation of the threaded nut as it moves up and down along the threaded lead screw, thereby preventing rotation of the flagpole and attached flag, and to provide support for the electromechanical actuator assembly.

The gear motor assembly 58 operates to rotate the lead screw and comprises a lead screw gear 38, a motor gear 36, a motor 30 having a rotatable shaft 60 connected to the motor gear 36, a gear plate 34 and a control electronics assembly 32.

The gear plate 34 is adapted to support the lead screw gear 38, motor gear 36 and motor 30 in cooperative alignment with each other to permit rotational movement of the lead screw gear 38 upon rotation of the motor shaft 60.

A magnet 42 attached to the bottom of the lead screw is adapted to provide magnetic coupling with the control electronics assembly 32.

The control electronics assembly 32 operates to connect power to the motor to rotate the motor shaft when the local actuator switch, or a switch or sensor connected to the remote actuator connector, is activated. The control electronics assembly also operates to disconnect power to the motor when the flagpole is in an extended or retracted position.

The control electronics assembly comprises a control system logic circuit 56 interfaced to a lead screw rotation sensor 54. The lead screw rotation sensor 54 is preferably a Hall-Effect sensor responsive to the magnetic field of the magnet 42 attached to the bottom of the threaded lead screw 40 to initiate a signal to the control system logic circuit 56 for each revolution of the lead screw. Accordingly, the control system logic circuit operates to start and stop the motor for a specified number of revolutions of the lead screw, using circuitry well known in the art. Each activation of the local or remote switch or sensor resets the control system logic circuit to reverse the direction of the motor shaft rotation.

The housing cover assembly 61 is attached to the upper end of the flagpole and is adapted to cover the mast housing opening when the flag and flagpole are in a retracted or stowed position, to provide a weatherproof enclosure for the flag, flagpole and electromechanical actuator assembly.

The housing cover assembly comprises a translucent light shell 18 with an enclosed lamp assembly 52. The lamp assembly is adapted to provide flashing or continuous light illumination, to attract attention in bright daylight and under low light conditions, using circuitry well known in the art.

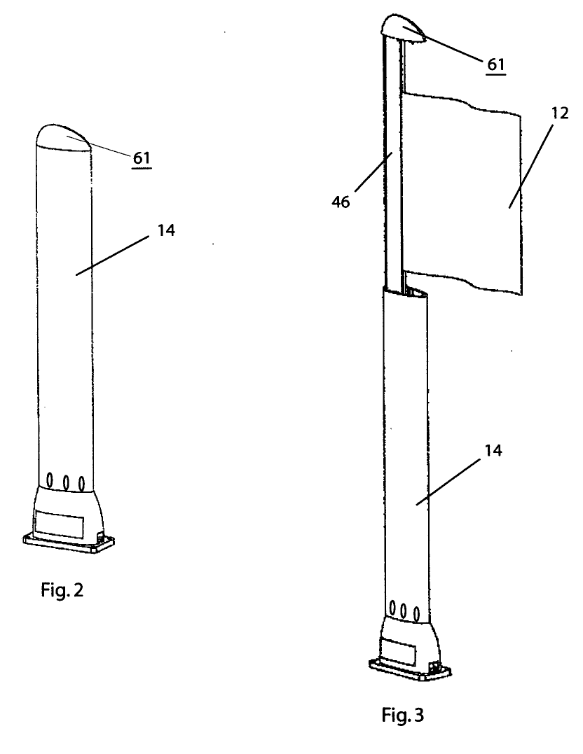

Operation of an apparatus of the invention begins with the flag stowed in the mast housing as shown in FIG. 2.

When the local actuator switch is pressed to deploy the flag, electrical power from the tow boat electrical system is directed to the motor causing the motor gear, lead screw gear and lead screw to rotate. Accordingly, the threaded nut, flagpole and flag move upward to raise the translucent light shell and extend the flag out of the mast housing. As indicated above, the threaded nut is prevented from rotating by one or more guide grooves along the interior wall of the mast housing.

Hall-effect sensors in the control electronics assembly count the number of revolutions of the lead screw and when the number of revolutions necessary to raise the flag out of the mast housing the required distance to fully expose the flag has been reached, the control electronics assembly disconnects power to the motor, leaving the flag in an extended position as illustrated in FIG. 3.

The gear motor assembly is preferably configured to permit deployment or retraction of the flag in approximately three seconds.

Following a command to retract the flag, the control electronics assembly causes the motor shaft, motor gear and lead screw gear to rotate in the reverse direction, lowering the flagpole and flag into the mast housing. When the selected number of rotations required to retract the flag into the mast housing has been reached, the control electronics assembly disconnects power to the motor, leaving the flag in the retracted position as illustrated in FIG. 2.

Alternative control of the invention can be provided by a remote switch located on a boat instrument panel as well as by a radio frequency link to an rf switch connected to the remote actuator connector.

Further, a tension sensor, mounted on the boat's towline attachment, can be connected to the remote actuator connector to actuate the invention when a skier has fallen by detecting a change in the towline tension.

Although the various features of novelty that characterize the invention have been described in terms of certain preferred embodiments, other embodiments will become apparent to those of ordinary skill in the art, in view of the disclosure herein. Accordingly, the present invention is not limited by the recitation of the preferred embodiments, but is instead intended to be defined solely by reference to the appended claims.

1. A signaling device for a water-skiing tow boat that can be activated to display and retract a flag into a housing, said signaling device adapted for attachment to the topside of a boat deck or support surface, said device not requiring mounting space below said support surface, said device comprising:
a flag;
housing means to enclose said flag;
electromechanical actuator means to extend said flag out of said housing means within approximately three seconds and to retract said flag into said housing means within approximately three seconds;
housing cover means to provide a cover for said housing means to weatherproof said housing means;
control means to activate said electromechanical actuator means; and
mounting base enclosure means to detachably mount said signaling device to said water-skiing tow boat.

2. The signaling device in accordance with claim 1, wherein said control means is a local actuator switch.

3. The signaling device in accordance with claim 1, wherein said control means is a remote actuator switch.

4. The signaling device in accordance with claim 1, wherein said control means is an external sensor.

5. The signaling device in accordance with claim 1, wherein said control means is a boat towline sensor.

6. The signaling device in accordance with claim 1, wherein said control means is operable by a radio frequency link.

7. The signaling device in accordance with claim 1, wherein said housing cover means includes an indicator light to attract attention in bright daylight and under low light conditions.

8. The signaling device in accordance with claim 1, wherein said signaling device is operated by a battery power supply source.

9. The signaling device in accordance with claim 1, wherein said housing means is adapted to prevent binding or tearing of said flag as said flag is extended and retracted.

10. The signaling device in accordance with claim 1, wherein said electro-mechanical actuator means comprises a gear motor and a rotating lead screw operative to move a flagpole and an attached flag to a retracted position in said housing means and to an extended position out of said housing means, said electromechanical actuator means further comprising a lead screw rotation sensor adapted to start and stop rotation of said rotating lead screw in respective retracted and extended positions.

11. The signaling device in accordance with claim 10, wherein said lead screw rotation sensor is a Hall Effect sensor responsive to a magnetic field of a magnet attached to said rotating lead screw and operable to start and stop the rotation of said rotating lead screw.

12. (Cancelled): The signaling device in accordance with claim 10, wherein said electro-mechanical actuator means operates to extend said flagpole and attached flag out of said housing means in about three seconds and to retract said flagpole and attached flag into said housing means in about three seconds.

13. The signaling device in accordance with claim 10, wherein said housing cover means is directly attached to said flagpole.

14. A signaling device for a water-skiing tow boat that can be activated to display and retract a flag into a housing, said signaling device adapted for attachment to the topside of a boat deck or support surface, said device not requiring mounting space below said support surface, said device comprising:
a flag;
a housing to enclose said flag;
an electromechanical actuator to extend said flag out of said housing within approximately three seconds and to retract said flag into said housing within approximately three seconds;
a housing cover to weatherproof said housing;
an operating control to activate said electromechanical actuator; and
a mounting base enclosure to detachably mount said signaling device to said water-skiing tow boat.

15. The signaling device in accordance with claim 14 wherein said electromechanical actuator comprises a gear motor and a rotating lead screw operative to move a flagpole and an attached flag to a retracted position in said housing and to an extended position out of said housing, said electromechanical actuator further comprising a lead screw rotation sensor adapted to start and stop rotation of said rotating lead screw in respective retracted and extended positions, said lead screw rotation sensor comprising a Hall Effect sensor responsive to a magnetic field of a magnet attached to said rotating lead screw and operable to start and stop the rotation of said rotating lead screw.

16. A portable signaling device for a water-skiing tow boat that can be activated to display and retract a flag into a housing, said signaling device detachably mounted to the topside of a boat deck or support surface, said device not requiring mounting space below said support surface, said device comprising:
a flag;
housing means to enclose said flag;
electromechanical actuator means to extend said flag out of said housing means within approximately three seconds and to retract said flag into said housing means within approximately three seconds;
housing cover means to provide a cover for said housing means to weatherproof said housing means;
control means to activate said electromechanical actuator means; and
mounting base enclosure means to detachably mount said signaling device to said water-skiing tow boat.
